(19) United States
(12) Patent Application Publication
(10) Pub. No.: US 2024/0050960 A1
(43) Pub. Date: Feb. 15, 2024

(54) DEVICE FOR TREATING WASTE FLUIDS AND METHOD OF IMPLEMENTING THE SAME

(71) Applicant: KEREN OXI LTD., Karmiel (IL)

(72) Inventor: Peter SHCHIOKIN, Karmiel (IL)

(21) Appl. No.: 18/013,320

(22) PCT Filed: Jun. 30, 2021
(86) PCT No.: PCT/IL2021/050806

§ 371 Date: Dec. 28, 2022

(30) Foreign Application Priority Data
Jul. 1, 2020 (IL) 275804

(51) Int. Cl. B03C 3/38; B01D 53/32; B03C 3/016; B03C 3/017; B03C 3/41

(52) U.S. Cl. CPC B03C 3/383; B01D 53/32; B03C 3/016; B03C 3/0175; B03C 3/41; B01D 2259/818; B01D 2257/708

(57) ABSTRACT

An electric discharge plasma device for treating waste fluid comprises: (a) at least one optical arrangement further comprising a laser source generating a laser radiation beam propagatable into a flow of the waste fluid and a laser beam distributor which spatiotemporally distributes the laser radiation beam within the flow such that a cloud of ionized gases containing electrically charged particles is created; and (b) an energizing arrangement transferring energy to the ionized gases containing electrically charged particles such that at least one of the following products an ionized gas, an oxidized contaminant, an ozone gas is generated.

### FIELD OF THE INVENTION

The present invention relates to purification of environmental discharge and, more particularly, to electric discharge plasma devices for treating waste fluids.

### BACKGROUND OF THE INVENTION

The standard precipitator contains a row of thin vertical wires, and followed by a stack of large flat metal plates oriented vertically. The air stream flows horizontally through the spaces between the wires, and then passes through the gaps between plates arranged into a stack.

A negative voltage of several thousand volts is applied to a wire electrode. If the applied voltage is high enough, an electric corona discharge ionizes the air around the electrodes, which then charges the particles in the fluid stream. The charged particles, due to the electrostatic force, are diverted towards the grounded plates. Particles build up on the collection plates and are removed from the air stream.

U.S. Pat. No. 9,931,641 discloses an air purification method and device. Due to the lower airflow resistance that the present invention induces, an exhaust fan or blower with motor of lower torque is adopted. Consequently, the whole air purification is operated at a lower noise level. Lower operational voltage is applicable for the high-voltage electrostatic precipitator device and provides a similar or superior performance and effectiveness for dust removal. Dust is removed from the environment by a high voltage electrostatic precipitator. The airflow stream within a high-voltage electrostatic precipitator is such that the direction of the path of the airflow is changed at least twice.

The disclosed technology is directed to lowering the high voltage applied to the electrodes embracing the waste gas flow by means of changing geometry of waste gas passages conducting the waste gas flow. The value of the voltage to be applied however can be lowered by preliminary partial ionization of the aforesaid wasted fluid to be treated. Thus, there is along-felt need for providing an electrostatic precipitator configured for initiating and maintaining the electric discharge between the electrodes at lower electric voltage.

### SUMMARY OF THE INVENTION

It is hence one object of the invention to disclose an electric discharge plasma device for treating waste fluid comprising: (a) at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created; (b) an energizing arrangement selected from the group consisting of at least one first electrode being in electric contact with said flow and carrying a voltage potential, at least one electric coil configured for creating a magnetic field within said flow, at least one capacitor plate configured for creating an electrostatic field within said flow and any combination thereof. The energizing arrangement is configured for transferring energy to said ionized gases containing electrically charged particles such that a product selected from the group consisting of: an ionized gas, an oxidized contaminant, an ozone gas and any combination thereof is generated.

Another object of the invention is to disclose the energizing arrangement comprises at least one second electrode carrying a high voltage potential opposite said at least one first electrode.

A further object of the invention is to disclose the electric voltage which is DC voltage.

A further object of the invention is to disclose the electric voltage which is AC voltage.

A further object of the invention is to disclose the magnetic field is strength of said magnetic field and direction thereof which are timely modulated.

A further object of the invention is to disclose the electrostatic field is strength of said electrostatic field and direction thereof which are timely modulated.

A further object of the invention is to disclose the flow of waste fluid conducted within a flue duct defined by a wall thereof.

A further object of the invention is to disclose the at least one optical arrangement mounted outside said flue duct such that said laser radiation beam distributed by said laser beam distributor propagates into said flue duct via an aperture within said wall.

A further object of the invention is to disclose the laser beam distributor which is a laser beam scanner selected from the group consisting of a mechanical mirror scanner, a Risley prism scanner, a lens scanner, an acousto-optical deflector and any combination thereof.

A further object of the invention is to disclose the laser beam distributor which is a diffraction optical element selected from the group consisting of a multi-order diffractive lens, a multi-order diffraction grating, a computer-generated holographic optical element and any combination thereof.

A further object of the invention is to disclose an electric discharge plasma device for treating waste fluid comprising: (a) at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created; (b) an energizing arrangement selected from the group consisting of at least one first electrode being in electric contact with said flow and carrying a voltage potential, at least one electric coil configured for creating a magnetic flux within said flow, at least one capacitor plate configured for creating an electrostatic field within said flow and any combination thereof. Contaminant particles of said waste fluid within said cloud of charged gases are at least partially negatively charged, and neutralized downstream said flow in proximity of said energizing arrangement; said neutralized contaminant particles are spontaneously coagulated and gravitationally droppable from said waste fluid.

A further object of the invention is to disclose the energizing arrangement comprising at least one second electrode carrying an electric potential opposite said at least one first electrode.

A further object of the invention is to disclose the at least one first electrode connected to a negative terminal of a power supply. The aforesaid at least one second electrode is connected to a positive terminal of said power supply; said contaminant particles negatively charged in proximity of said first electrode and flowing downstream to said at least one second electrode, charged particles diverted towards opposite charged cloud and are electrically neutralized in proximity of said at least second electrode and spontaneously coagulated thereafter.

A further object of the invention is to disclose the flue duct comprising a blow-down branch being in communication with a hopper.

A further object of the invention is to disclose the at least one of said first and second electrodes embracing at least a part of said waste fluid flow.

A further object of the invention is to disclose the plasma device comprising at least one turbulator configured for converting a laminar flow of waste fluid into a turbulent flow of waste fluid.

A further object of the invention is to disclose a method of treating waste fluid comprising steps of: (a) providing an electric discharge plasma device further comprising: (i) at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created; (ii) an energizing arrangement selected from the group consisting of at least one first electrode being in electric contact with said flow and carrying a voltage potential, at least one electric coil configured for creating a magnetic field within said flow, at least one capacitor plate configured for creating an electrostatic field within said flow and any combination thereof; (b) generating a laser radiation; (c) distributing said laser beam in proximity of said at least one first electrode; (d) creating a cloud of ionized gases; and (e) transferring energy to said cloud of ionized gases containing electrically charged particles such that a product selected from the group consisting of: an ionized gas, an oxidized contaminant, an ozone gas and any combination thereof is generated.

A further object of the invention is to disclose a method of treating waste fluid comprising steps of: (a) providing an electric discharge plasma device further comprising:
(i) at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created; and (ii) an energizing arrangement selected from the group consisting of at least one first electrode being in electric contact with said flow and carrying an electric potential, at least one electric coil configured for creating a magnetic flux within said flow, at least one capacitor plate configured for creating an electrostatic field within said flow and any combination thereof; (b) generating a laser radiation; (c) distributing said laser beam in proximity of said at least one first electrode; (d) creating a cloud of ionized gases; (e) transferring energy to said cloud of ionized gases containing electrically charged particles; (f) negatively charging said contaminant particles; (g) electrically neutralizing said contaminant particles; (h) spontaneously coagulating electrically neutralized contaminant particles; and (i) gravitationally dropping coagulated contaminant particles from said waste fluid flow.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic diagram of a one-electrode electric discharge plasma device for treating waste fluid;

FIG. 2 is a schematic diagram of a two-electrode electric discharge plasma device for treating waste fluid;

FIG. 3 is a schematic diagram of an electric discharge plasma device for treating waste fluid with a capacitive energizing arrangement;

FIG. 4 is a schematic diagram of an electric discharge plasma device for treating waste fluid with a inductive energizing arrangement;

FIG. 5 is a schematic diagram of an electric discharge plasma device for treating waste fluid with a diffractive energizing arrangement;

FIG. 6 is a schematic diagram of a first embodiment of a plasma device for treating waste fluid functioning as an electric discharge plasma precipitator;

FIG. 7 is a schematic diagram of a second embodiment of a plasma device for treating waste fluid functioning as an electric discharge plasma precipitator; and

FIG. 8 is a schematic diagram of a third embodiment of a plasma device for treating waste fluid functioning as an electric discharge plasma precipitator.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide an electric discharge plasma device for treating waste fluid and a method of doing the same.

The term “spaciotemporal distribution” hereinafter refers to distribution laser radiation within a volume of interest by means of dynamically changing propagation direction of a laser radiation beam withing the aforesaid volume of interest or statically splitting the laser radiation beam into a plurality of laser beams propagating within the volume of interest.

According to an exemplary embodiment a laser beam generated by an ytterbium fiber laser having an output at wavelengths from 1.03 to 1.1 μm is angularly distributed in a dynamic or static manner such that laser beam forms a conic illumination field.

According to the present invention, any laser beam scanning device such as a mechanical mirror scanner, a Risley prism scanner, a lens scanner, an acousto-optical deflector can be considered as a dynamic laser beam distributor.

Each of a multi-order diffractive lens, a multi-order diffraction grating, a computer-generated holographic optical element can function as a static laser beam distributor.

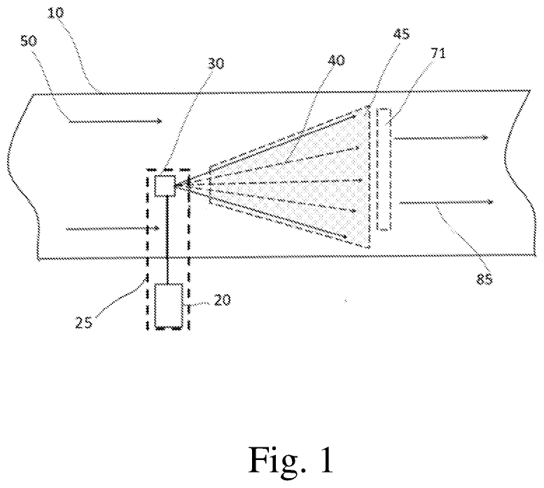

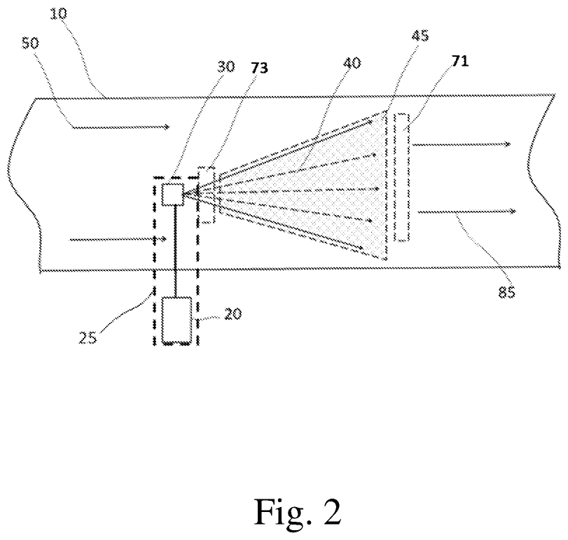

Reference is now made to FIGS. 1 and 2 presenting an electric discharge plasma device for treating waste fluid, which is designed for ionizing the aforesaid fluid and and/or oxidizing the contaminants contained therewithin. FIG. 1 shows an embodiment including one unipolar electrode 71, while FIG. 2 corresponds to two opposite electrodes 71 and 73.

Referring to FIG. 1, duct 10 conducts gas flow 50 to be treated. Optical arrangement 25 is configured for ionizing the flow of waste gases within volume 45 by energy of a radiation generated by laser 20 and dynamically distributed by laser beam scanner 30 in proximity of electrode 71. Numeral 40 refers to one possible position of scanned beam.

Reference is now made to FIG. 2, presenting a two-electrode embodiment of the electric discharge plasma device depicted in FIG. 1. The voltage applied to electrodes 71 and 73 energize the flow ionized by optical arrangement 25 in the interelectrode gap such that at least part of contaminants contained in the waste fluid is oxidized within the interelectrode gap. According to one embodiment of the present invention, one of electrodes 71 and 73 is frusto-fulcrum-shaped and embraces at least a part of the interelectrode gap.

Electrodes 71/73 are configured for transferring electric energy to ionized gas cloud. As the result, at least one product of the following: an ionized gas, an oxidized contaminant and an ozone gas is generated. The fluid flowing in direction 85 includes at least one of the mentioned products.

Practical efficiency of generation of the abovementioned products depends on fluid pressure and temperature, its absorption at the wavelength of laser generation, electric strength of applied electric field, specific contaminants carried by the fluid to be treated gas and other parameters.

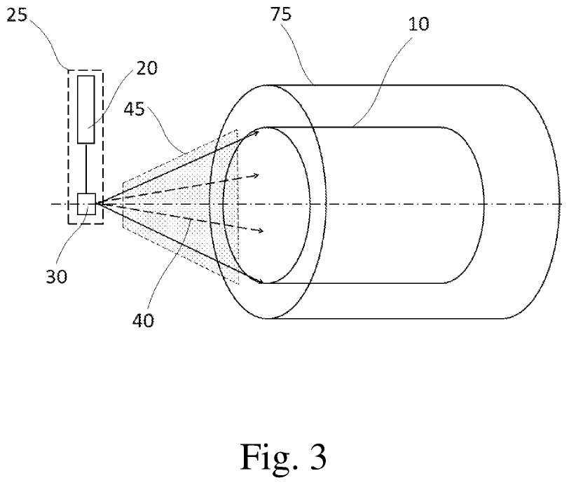

Reference is now made to FIG. 3 presenting an embodiment of the present invention including at least one capacitor plate 75 disposed out of duct 10. Contrary to the embodiments depicted in FIGS. 1 and 2 having one or two electrodes which are in direct electric contact with flow of waste fluid, at least one capacitor plate 75 is disengaged from flow conducted within a passage defined by a dielectric wall of duct 10. An electric field within area 45 between capacitor plate 75 and the ground or between two capacitor plates 75 (not shown) a volumetric cloud of induced electric charges.

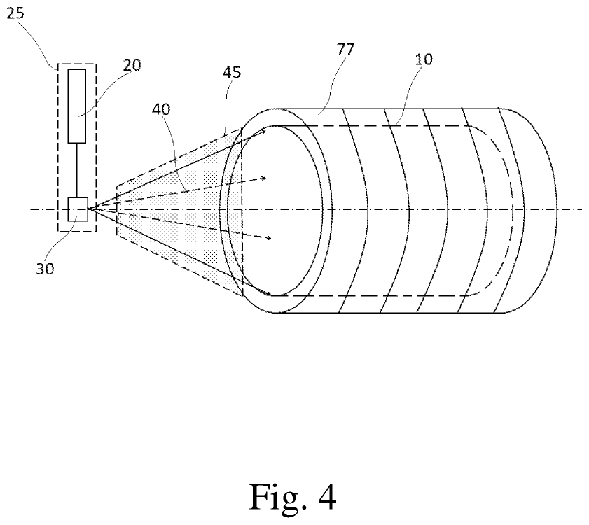

Reference is now made FIG. 4 presenting an embodiment of the present invention including at least one electric coil 77 configured for creating a magnetic field within flow of waste gases. At least one electric coil 77 is under AC voltage and creates oscillating magnetic field within the fluid flow. The ionized fluid cloud in area 45 as a conductive medium is further energized on the basis of eddy currents created by the abovementioned oscillating magnetic field.

Practical efficiency of generation of the abovementioned products depends on fluid pressure and temperature, its absorption at the wavelength of laser generation, electric strength of applied electric field, specific contaminants carried by the fluid to be treated gas and other parameters.

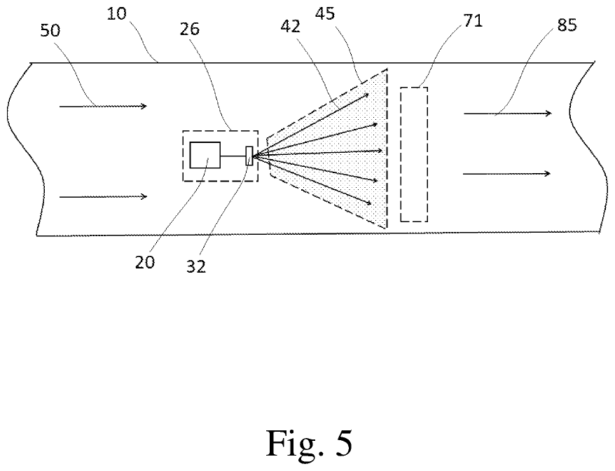

Reference is now made to FIG. 5 presenting an electric discharge plasma device for treating waste fluid provided with static laser radiation distributor 26 including laser 20 and a diffractive optical element which is selected from the group consisting of: diffraction optical element selected from the group consisting of a multi-order diffractive lens, a multi-order diffraction grating, a computer-generated holographic optical element. Any of the mentioned element is configured for splitting the incident laser radiation beam into a plurality of beams propagating within volume 45 such that the flow of waste fluid is ionized.

Practical efficiency of generation of the abovementioned products depends on fluid pressure and temperature, its absorption at the wavelength of laser generation, electric strength of applied electric field, specific contaminants carried by the fluid to be treated gas and other parameters.

### Example 1

Laser-induced fluid ionizer. Energy transfer needed for ionizing a wide class of organic molecules which are potential contaminants in the fluid to be treated is in range between 8 to 18 eV. Ionization potential of methane is about 13 eV.

### Example 2

Laser-induced ozone generation is possible under crossing potential barrier corresponding energy about 20 to 25 eV. Estimated specific consumption is about less than 1.2 kWh per 100 g of ozone.

### Example 3

Laser-induced fluid oxidizer. Energy to be transferred is greater than 35 eV.

The laser-induced fluid oxidizer is applicable to manufacturing and storing animal feed for dust elimination and deodorization. The laser-induced fluid oxidizers can useful for eliminating volatile organic compounds and particulate-laden residue contained in waste gases at power or thermal plants and other facilities firing any kind of organic fuel before exhausting waste gases into atmosphere.

After emptying the tanks and before or during refilling the same tank by liquids (oil, gas) the gases that are emission from the tank should be cleaned from the VOCs.

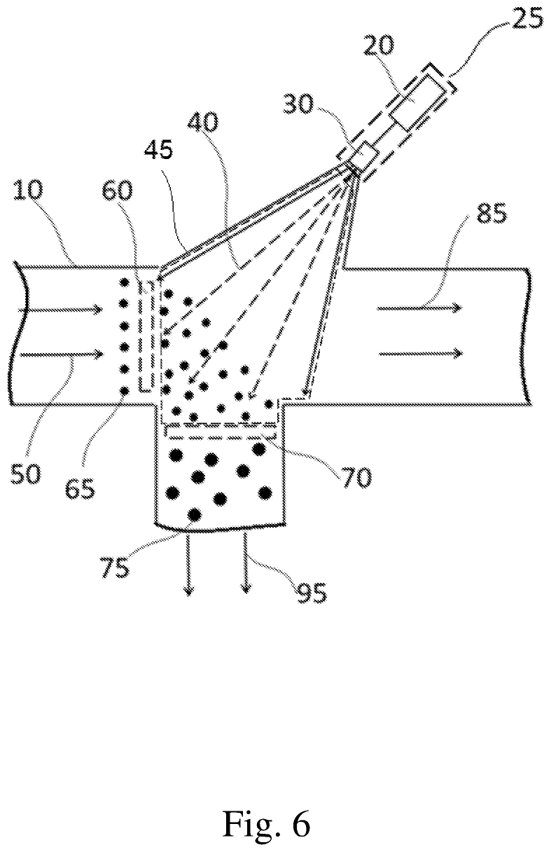

Reference is now made to FIGS. 6 to 8 presenting alternative embodiments of a laser-assisted electric discharge plasma precipitator. The plasma device is mountable in any conduit conducting a waste fluid flow such as a flue duct 10. Numerals 60 and 70 refer to electrodes electrically connected a power supply (not shown).

Referring to FIG. 6, waste fluid flow to be treated 50 carries contaminant particles 65. Laser radiation 40 generated by laser source 20 is displaceable by laser scanner 30 creates a cloud of ionized waste fluid within volume 45 in proximity to electrodes 60 and 70. Electrodes 60 and 70 are disposed at a periphery of a flue-duct cross section in order to encompass the waste fluid flow therewithin and configured for energizing contaminants particles 65 such that contaminants particles 65 are negatively charged in proximity of electrode 60. Becoming negatively charged, contaminant particles 65 change their trajectory under electrostatic field created between electrodes 60 and 70. Specifically, contaminant particles 65 are attracted to positive electrode 70 and electrically neutralized in proximity of electrodes 70. It should be mentioned that electrically neutral contaminant particles 65 being in the non-uniform electrostatic field between electrodes 60 and 70 stay electrically polarized and prone to spontaneously coagulation. Coagulated contaminant particles 75 gravitationally drop in the direction 95 into a hopper (not shown). Arrows 85 denote a direction of a flow of clean fluid substantially free of contaminant particles.

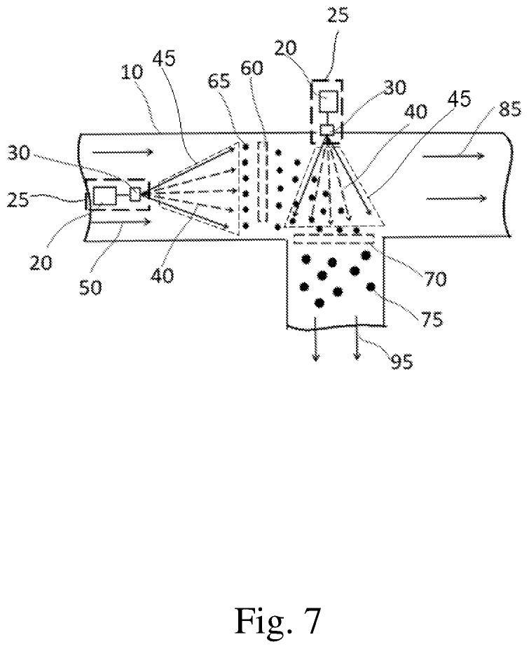

Reference is now made to FIG. 7 presenting an alternative embodiment of an electric discharge plasma device for treating waste fluid. The present embodiment is characterized two optical arrangements 25 configured for ionizing the fluid of waste fluid in proximity of electrodes 60 and 70. It should be mentioned that arrangements 25 within flue duct 10, partially in duct 10 or outside duct 10 is in the scope of the present invention. Laser radiation from arrangements 25 are directed to electrodes 60 and 70 each. Processes of charging contaminant particles 65, their neutralizing and coagulating are identical to the disclosed above.

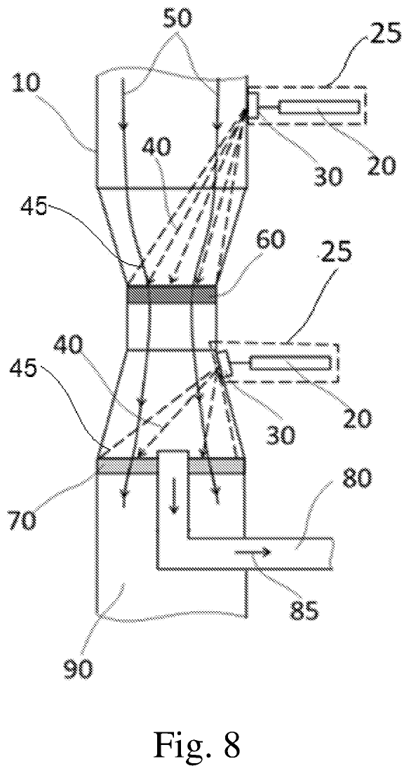

Reference is now made to FIG. 8 presenting an alternative embodiment of an electric discharge plasma device for treating waste fluid. While FIGS. 6 and 7 show the embodiments characterized by horizontal orientation of the fluid flow, in FIG. 8, contaminant particles when charged in proximity of negative electrode 60 is attracted by positive electrode 70 to periphery of flue duct 10. As mentioned above, in proximity of positive electrode 70, contaminant particles are electrically neutralized and coagulated. As a consequence, coagulated particles of contaminants drop into hopper 90. Contaminant-free fluid is drawn in direction 85.

It should be appreciated that generating an ionized gas, an oxidized contaminant or an ozone gas in the embodiments of the plasma device shown in FIGS. 6 to 8 is also in the scope of the present invention.

The plasma device shown in FIGS. 6 to 8 functions as a contaminant precipitator. The electrical voltage corresponding to the precipitating mode is in the range between 5 kV and 5000 kV.

Certain changes may be made in the above methods and systems without departing from the scope of that which is described herein. It is to be noted that all matter contained in the above description or shown in the accompanying drawings is to be interpreted as illustrative and not in a limiting sense. For example, the devices shown in FIGS. 1 through 8 may include different components than those shown in the drawings. The following claims are intended to cover all generic and specific features described herein, as well as all statements of the scope of the present devices, which, as a matter of language, might be said to fall there between.

1.-26. (canceled)

27. An electric discharge plasma device for treating waste fluid comprising:
a. at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created;
b. an energizing arrangement selected from the group consisting of at least one first electrode being in electric contact with said cloud and carrying a voltage potential, at least one electric coil configured for creating a magnetic field within said cloud, at least one capacitor plate configured for creating an electrostatic field within said cloud and any combination thereof;
said energizing arrangement is configured for transferring energy to said cloud of ionized gases containing electrically charged particles such that a product selected from the group consisting of: an ionized gas, an oxidized contaminant, an ozone gas and any combination thereof is generated.

28. The plasma device according to claim 27, wherein said energizing arrangement comprises at least one second electrode carrying a high voltage potential opposite said at least one first electrode.

29. The plasma device according to claim 27, wherein at least one of the following is true:
a. strength of said magnetic field and direction thereof are timely modulated; and
b. strength of said electrostatic field and direction thereof are timely modulated.

30. The plasma device according to claim 27, wherein said flow of waste fluid is conducted within a flue duct defined by a wall thereof.

31. The plasma device according to claim 27, wherein said at least one optical arrangement is mounted outside said flue duct such that said laser radiation beam distributed by said laser beam distributor propagates into said flue duct via an aperture within said wall.

32. The plasma device according to claim 27, wherein at least one of the following is true:
a. said laser beam distributor is a laser beam scanner selected from the group consisting of a mechanical mirror scanner, a Risley prism scanner, a lens scanner, an acousto-optical deflector and any combination thereof; and
b. said laser beam distributor is a diffraction optical element selected from the group consisting of a multi-order diffractive lens, a multi-order diffraction grating, a computer-generated holographic optical element and any combination thereof.

33. An electric discharge plasma device for treating waste fluid; said device comprising:
a. at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created;
b. an energizing arrangement selected from the group consisting of at least one first electrode being in electric contact with said cloud and carrying a voltage potential, at least one electric coil configured for creating a magnetic flux within said cloud, at least one capacitor plate configured for creating an electrostatic field within said cloud and any combination thereof;
contaminant particles of said waste fluid within said cloud of charged gases are at least partially charged and neutralized downstream said flow in proximity of said energizing arrangement; said neutralized contaminant particles are spontaneously coagulated and gravitationally droppable from said waste fluid.

34. The plasma device according to claim 33, wherein said energizing arrangement comprises at least one second electrode carrying an electric potential opposite said at least one first electrode.

35. The plasma device according to claim 33, wherein said at least one first electrode is connected to a negative terminal of a power supply, said at least one second electrode is connected to a positive terminal of said power supply; said contaminant particles negatively charged in proximity of said first electrode and flowing downstream to said at least one second electrode are electrically neutralized in proximity of said at least second electrode and spontaneously coagulated thereafter.

36. The plasma device according to claim 33, wherein strength of said magnetic field and direction thereof are timely modulated.

37. The plasma device according to claim 33, wherein strength of said electrostatic field and direction thereof are timely modulated.

38. The plasma device according to claim 33, wherein said flow of waste fluid is conducted within a flue duct defined by a wall thereof.

39. The plasma device according to claim 33, wherein said flue duct comprises a blow-down branch being in communication with a hopper.

40. The plasma device according to claim 33, wherein at least one of said first and second electrodes embraces at least a part of said waste fluid flow.

41. The plasma device according to claim 33 comprising at least one turbulator configured for converting a laminar flow of waste fluid into a turbulent flow of waste fluid.

42. The plasma device according to claim 37, wherein said at least one laser source and laser beam distributor are mounted outside said flue duct such that said laser radiation beam distributed by said laser beam distributor propagates into said flue duct via an aperture within said wall.

43. The plasma device according to claim 37, wherein said laser beam distributor is a laser beam scanner selected from the group consisting of a mechanical mirror scanner, a Risley prism scanner, a lens scanner, an acousto-optical deflector and any combination thereof.

44. The plasma device according to claim 37, wherein said laser beam distributor is a diffraction optical element selected from the group consisting of a multi-order diffractive lens, a multi-order diffraction grating, a computer-generated holographic optical element and any combination thereof.

45. A method of treating waste fluid comprising steps of:
a. providing an electric discharge plasma device further comprising:
i. at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created; and
ii. an energizing arrangement selected from the group consisting of at least one first electrode being in electric contact with said cloud and carrying a voltage potential, at least one electric coil configured for creating a magnetic field within said cloud, at least one capacitor plate configured for creating an electrostatic filed within said cloud and any combination thereof;
b. generating a laser radiation;
c. distributing said laser beam in proximity of said at least one first electrode;
d. creating a cloud of ionized gases; and
e. transferring energy to said cloud of ionized gases containing electrically charged particles such that a product selected from the group consisting of: an ionized gas, an oxidized contaminant, an ozone gas and any combination thereof is generated.

46. A method of treating waste fluid comprising steps of:
a. providing an electric discharge plasma device further comprising:
i. at least one optical arrangement further comprising at least one laser source configured for generating a laser radiation beam propagatable into a flow of said waste fluid and a laser beam distributor configured for spatiotemporally distributing said laser radiation beam within said flow such that a cloud of ionized gases containing electrically charged particles is created; and
ii. an energizing arrangement selected from the group consisting of at least one first electrode being in electric contact with said cloud and carrying an electric potential, at least one electric coil configured for creating a magnetic flux within said cloud, at least one capacitor plate configured for creating an electrostatic filed within said cloud and any combination thereof;
b. generating a laser radiation;
c. distributing said laser beam in proximity of said at least one first electrode;
d. creating a cloud of ionized gases;
e. transferring energy to said cloud of ionized gases containing electrically charged particles;
f. charging said contaminant particles;
g. electrically neutralizing said contaminant particles;
h. spontaneously coagulating electrically neutralized contaminant particles; and
i. gravitationally dropping coagulated contaminant particles from said waste fluid flow.
